(19) United States
(12) Patent Application Publication
(10) Pub. No.: US 2014/0265258 A1
(43) Pub. Date: Sep. 18, 2014

(54) DETACHABLE SIDE-BY-SIDE STROLLER

(71) Applicant: Pooya Lalehzri, New Hyde Park, NY (US)

(72) Inventor: Pooya Lalehzri, New Hyde Park, NY (US)

(21) Appl. No.: 13/797,520

(22) Filed: Mar. 12, 2013

(51) Int. Cl. B62B 7/00

(52) U.S. Cl. CPC B62B 7/008
USPC 280/658

(57) ABSTRACT

The present disclosure is directed to a detachable side-by-side double stroller comprising an Interlacing-Interlocking Mechanism (“IIM”) that allows the two sub-unit strollers to attach and detach efficiently, easily, and without the use of detachable or foldable wheels. The IIM comprises a first portion of a rear axle at a first angle to the ground, and a second portion of a rear axle at a second, different angle. The first portion of the axle has a channel, oriented along the second angle, with a width equal to a corresponding width of the second portion of the axle. The channel may include one or more pins or ridges to mate with one or more corresponding holes or channels in the second portion of the axle. The IIM may include a lock or latching mechanism to prevent unintentional separation of the strollers.

### RELATED APPLICATIONS

This application claims priority to and the benefit of commonly-owned and co-pending U.S. Provisional Application No. 61/719,679, filed Oct. 29, 2012, the entirety of which is hereby incorporated by reference.

### FIELD OF THE DISCLOSURE

The present disclosure relates to children's strollers. In particular, the present disclosure relates to strollers that may be attached in a side-by-side configuration to form a double stroller.

### BACKGROUND OF THE DISCLOSURE

Families or caregivers tending more than one child frequently have a need for multiple strollers. Multiple individual strollers may be difficult for a single caretaker to maneuver, particularly as the number of children carried by the strollers increases. Multi-child strollers allow a single caretaker to transport multiple children, but may be bulky and difficult to pass through narrow entryways. Additionally, as strollers typically utilize rotating front wheels for turning, multi-child strollers may have larger turning radii than desirable.

For example, and referring briefly to FIG. 7, illustrated is a diagram of an embodiment of a single-child stroller 700. As shown, in many embodiments, a single stroller 700 may have four wheels deposed in front and rear pairs to form a stable box. In many embodiments, stroller 700 may have at least two of its wheels 701 on a side of the stroller placed slightly outwards of the stroller's seat frame and the center of mass of the stroller, as well as two wheels on the opposing side of the stroller 700 (not illustrated) similarly placed outwards of the seat frame. This may add stability to the carriage against toppling that could occur when a child pivots or leans himself or herself on a side of the stroller 700. Due to this safety feature, if two strollers 700 were to be placed next to each other, the outer wheels 701 of each stroller would be in contact and would prevent the frame of each stroller 700 from fully sitting adjacent to the other stroller without some wasted space between them. This limitation is referred to as the “Width Limitation” in this document.

Additionally, in typical implementations, front wheels 702 of a stroller 700 may rotate around their vertical axes to facilitate steering or rotation of the stroller. On a standard single stroller 700 where the wheels are placed on the four corners of the frame as shown in FIG. 7, the rotation of the front wheels 702 around their vertical axes will cause these wheels to rotate out to the sides into the space outside the frame of the stroller 700. Again, if two strollers 700 are placed next to each other in a side-by-side configuration, during rotation or steering, the front wheels 702 on the connection side between the two strollers 700 will collide as they rotate outside of their respective frames, interfering with proper steering. This limitation is referred to as the “Rotating Wheel Limitation” in this document.

One attempt to circumvent the Rotating Wheel Limitation is to replace the paired front wheels 702 with a single, central wheel 702, or to offset the front wheels 702 inside the frame of the stroller 700, such that circumference of the circle(s) created by the rotation of the front wheel(s) around their respective vertical axes would be fully within the frame of the stroller 700. However, this may reduce stability of the stroller 700, and require the rear wheels to be placed farther apart such that a line from a rear wheel to the front wheel or same-side wheel is outside of the region in which the child is likely to lean. Accordingly, typical efforts to rectify the Rotating Wheel Limitation will result in an exacerbated Width Limitation and will create an undesirably wide double stroller where its handling and its ability to pass through doors would be significantly hampered.

Other attempts to balance safety and maneuverability result in inadequate implementations that require detaching or folding the wheels of each stroller 700 at the connection point, or attaching the two strollers 700 through extensions that keep the front wheels 702 clear from each other. Such implementations either complicate the attachment/detachment process, or drastically increase the total width of the coupled configuration, respectively.

### BRIEF SUMMARY OF THE DISCLOSURE

The present disclosure is directed to a detachable side-by-side double stroller with an easy attachment/detachment mechanism, allowing the two strollers to be attached and detached on-demand and on-the-go as various situations are encountered by users that require two independent strollers or a double stroller. The double stroller incorporates an Interlacing-Interlocking Mechanism (“IIM”) that allows the two sub-unit strollers to attach and detach efficiently, easily, and without the use of detachable or foldable wheels. Although discussed as an interlacing-interlocking mechanism, in many embodiments, the mechanism may only interlace the axles of the strollers, and a locking or securing feature may be provided by a separate clamp, latch, or other mechanism. The IIM comprises a first portion of a rear axle at a first angle to the ground, and a second portion of a rear axle at a second, different angle. The first portion of the axle has a channel, oriented along the second angle, with a width equal to a corresponding width of the second portion of the axle. In some embodiments, the channel includes one or more pins or ridges to mate with one or more corresponding holes or channels in the second portion of the axle. In many embodiments, the IIM may further comprise a lock or latching mechanism to prevent unintentional separation of the strollers, such as a lever, release button, clamp, or other such mechanism. The strollers may further have a latch or locking mechanism to join a portion of the frame of each stroller at a second attachment point, such as near the front of each stroller. To join two strollers, the user mates the first portion of an axle of a first stroller with the second portion of an axle of a second stroller via the channel, preventing lateral motion of the strollers against each other. In many embodiments, the total width of the fully attached double configuration may be sized to fit through a standard doorway, around 30″ in total width, and in many embodiments, less than 35″ in total width.

In order to address the Rotating Wheel Limitation, in many embodiments of the double stroller of the present disclosure, the front wheel(s) of each stroller may be placed inwards of the stroller frame. When interlocked with a second stroller, the widely spaced rear wheels address the Width Limitation while interlacing to allow narrower overall width. Tipping is less of a concern due to the counterweight of the second stroller. When in a single stroller configuration, the wide back wheel span provides necessary stability against tipping. The axles may be formed such that they may interlace and interlock with an easy detaching mechanism (for example but not limited to a button, or a lever, or a clamp, not shown in the drawings) embedded in one of the axles that would release the connection points on the axle, when desired.

In one aspect, the present disclosure is directed to a detachable stroller for a side-by-side double stroller configuration. The stroller includes a frame providing support for a seat for a child or infant. The stroller also includes at least one front axle attached to the frame, the at least one front axle attached to a corresponding at least one wheel. The stroller further includes at least one back axle attached to the frame. The back axle includes a first portion of the back axle at a first angle to the ground, attached to the frame and attached to a second at least one wheel, comprising a channel of a first width across the first portion of the back axle at a second, different angle, and a second portion of the back axle of the first width at the second angle, attached to the frame and attached to a third at least one wheel.

In one embodiment of the stroller, the channel further comprises at least one pin or ridge, and wherein the second portion of the back axle further comprises a corresponding at least one hole or channel. In another embodiment of the stroller, the back axle further comprises a latch or clamp to secure the first portion of the back axle of the detachable stroller to a corresponding second portion of a back axle of a second detachable stroller. In still another embodiment of the stroller, the back axle further comprises a spring and pin attached to the spring to secure the first portion of the back axle of the detachable stroller to a corresponding second portion of a back axle of a second detachable stroller, and further comprising a release button to release the pin.

In some embodiments, the stroller includes a latch attached to the frame for connection to a corresponding portion of a frame of a second detachable stroller. In other embodiments of the stroller, the back axle further comprises a third portion attached between the first portion and second portion, attached to the frame, said third portion having a height above ground of greater than a diameter of the second and third at least one wheels. In still other embodiments, the frame further comprises a rail slidingly attached to the seat to allow the seat to move laterally between the center of the frame and a second predetermined position. In a further embodiment of the stroller, the rail includes a latch to prevent lateral movement of the seat in a single stroller configuration.

In another aspect, the present disclosure is directed to an interlacing mechanism for a double stroller. The mechanism includes a base for attachment to a first portion of a rear axle of a first stroller, the first portion at a first angle to the ground. The mechanism also includes a channel, attached to the base, for attachment to a second portion of a rear axle of a second stroller, the second portion at a second, different angle, the channel at the second angle and having a width of at least a width of second portion of the rear axle of the second stroller. The first portion of the rear axle of the first stroller and the second portion of the rear axle of the second stroller interlace when connected to the interlacing mechanism.

In one embodiment, the mechanism includes at least one pin or ridge attached to the channel for protruding into a corresponding at least one pin or channel of the second portion of the rear axle of the second stroller. In another embodiment, the mechanism includes a clamp attached to the base for attachment to the first portion of the rear axle of the first stroller. In yet another embodiment, the mechanism includes a clamp attached to the channel for attachment to the second portion of the rear axle of the second stroller. In still another embodiment, the mechanism includes a latch attached to the channel for attachment to the second portion of the rear axle of the second stroller. In yet still another embodiment, the mechanism includes a pin attached to a spring attached to the channel for attachment to the second portion of the rear axle of the second stroller, and further comprising a release button attached to the spring.

In still another aspect, the present disclosure is directed to a detachable double stroller with an interlacing mechanism. The double stroller includes a first stroller comprising: a first frame providing support for a seat for a first child or infant; a first at least one front axle attached to the frame, the at least one front axle attached to a corresponding first at least one wheel; and a first at least one back axle attached to the frame comprising a first portion of the back axle at a first angle to the ground, attached to the first frame and attached to a third at least one wheel, comprising a channel of a first width across the first portion of the back axle at a second, different angle. The double stroller also includes a second stroller comprising a second frame providing support for a seat for a second child or infant; a second at least one front axle attached to the frame, the at least one front axle attached to a corresponding fourth at least one wheel; and a second at least one back axle attached to the frame comprising a second portion of the back axle of the first width at the second angle, attached to the second frame and attached to a fifth at least one wheel. The first stroller and second stroller are coupled with the second portion of the back axle of the second stroller detachably fastened in the channel of the first portion of the back axle of the first stroller.

In some embodiments, when the first stroller and second stroller are coupled, the third at least one wheel attached to the first portion of the back axle of the first stroller is beneath the second frame of the second stroller, and the fifth at least one wheel attached to the second portion of the back axle of the second stroller is beneath the first frame of the first stroller.

In other embodiments, the first portion of the back axle of the first stroller further comprises at least one pin or ridge attached to the channel; and the second portion of the back axle of the second stroller further comprises a corresponding at least one pin or channel.

In one embodiment, the first portion of the back axle of the first stroller or the second portion of the back axle of the second stroller further comprises a latch for securing the first portion and second portion together in a coupled configuration.

In some embodiments, when the first stroller and second stroller are coupled, the total width of the double stroller is between 24 and 40 inches. In other embodiments, the first frame of the first stroller further comprises a first rail slidingly attached to the first seat to allow the first seat to move laterally between the center of the first frame and a second predetermined position; and the second frame of the second stroller further comprises a second rail slidingly attached to the second seat to allow the second seat to move laterally between the center of the second frame and a third predetermined position, the third predetermined position in an opposite direction from the second predetermined position.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1 is an illustration of an embodiment of a detachable side-by-side stroller with an interlacing-interlocking mechanism in a double configuration;

FIG. 2 is an illustration of an embodiment of the detachable side-by-side stroller of FIG. 1 in a single configuration and used as a stand-alone single stroller;

FIGS. 3 and 4 are illustrations of embodiments of an interlacing-interlocking mechanism of a detachable side-by-side stroller in uncoupled and coupled configurations, respectively;

FIG. 5 is an illustration of an embodiment of an attachment mechanism for coupling a front portion of a detachable side-by-side stroller;

FIGS. 6A and 6B are top view diagrams of embodiments of interlacing detachable side-by-side strollers incorporating laterally sliding seats; and

FIG. 7 is an illustration of a typical single stroller.

### DETAILED DESCRIPTION

Referring first to FIG. 1, illustrated is a stroller of the present disclosure in double configuration. The picture illustrates how the double configuration can function properly without the need for folding or detaching any of the front or back wheels. The figure also illustrates efficient coupling of the two strollers and there lack of any dead-space between the two strollers due to the expanded back wheel-span, required for the stability of the single configuration of the stroller. FIG. 1 shows how, in some implementations, the handles 101 from each stroller line up with their counterparts to provide a level handle line for the double configuration. The handles 101 of each single stroller may be designed as a single continuous bar as shown, or may comprise a pair of left and right handles.

FIG. 2 illustrates a separated view of the double stroller of FIG. 1 where each single stroller can function as a stand-alone fully functional and stable stroller. This single stroller may be sold as a stand-alone carriage with the additional capability of attaching to another stroller compatible with an interlacing-interlocking mechanism (IIM). This option may provide flexibility for growing families.

FIGS. 3 and 4 depict an embodiment of an IIM allowing for a space-efficient attachment of the two back axles 301 of the strollers, where the wider wheel-span, needed for stability, would have otherwise prevented the two strollers to attach without a dead-space between them. Additionally the IIM allows for the two strollers to be anchored and attached to each other without any removable or foldable wheels. As shown, each axle 301 may include a central portion, which may be horizontal or may have other bends or features. As shown in FIG. 4, a portion of each axle 301 may extend downwards at an angle 401 to the ground (illustrated in dashed line) and attach at a distal end to a wheel. Each portion may, in some embodiments, extend laterally from the central portion of the axle 301 as shown. In other embodiments not illustrated, each portion may extend in an anterior or posterior direction or be offset forwards or backwards. Accordingly, while in some embodiments angle 401 may be with respect to the ground and on a plane normal to the ground and bounded by the central portion of the axle and a line extending between each rear wheel, in other embodiments, the angle may be rotated or offset such that rear wheels are offset forward or rearward from the central portion of the axle 301. In many embodiments, the angle 401 may be a 45 degree angle, while in other embodiments, any other angle 401 may be used. A corresponding second portion of each axle 301 may be at a second angle, which may be perpendicular to the first angle 401 as shown, or may be at a different angle. For example, a first portion may be at a 60 degree angle to the ground, and the second portion may also be at a 60 degree angle to the ground, creating a 60 degree angle between the first portion and second portion. This may allow for the two strollers to have similar and symmetrical axles with the same angle 401 relative to the ground or a horizontal portion of the axle 301 at a distal end 402 attaching to a wheel. Additionally, as shown, in some embodiments, a portion of axle 301 may extend downwards at angle 401, while a second portion of the same axle 301 may not extend downwards at the angle or may extend downwards at a different angle. For example, in some embodiments, a first stroller of a double stroller pair may be designated as the “left” stroller. A leftmost portion of its axle will be outboard when joined to its partner in a side-by-side configuration, and may be at any angle. The rightmost portion of its angle may extend at angle 401. Correspondingly, the second stroller of a double stroller pair designated as the “right” stroller may have a leftmost portion of its axle extending at angle 401 or a corresponding angle to 401, while a rightmost portion of its angle may be outboard in a side-by-side configuration and may be at any angle. This may result in a narrower overall form when in a side-by-side configuration, as the outboard wheel of each stroller need not extend outwards very far.

As shown in FIG. 3, attachment or IIM 302 may include a channel. The channel may be at an angle corresponding to angle 401 of FIG. 4 or at an angle of the corresponding second portion of the axle 301 of a second stroller, allowing the axle of the second stroller to interlock in the channel. In some embodiments, angle 401 might be different for the left stroller relative to the right in order to provide a level handle bar 101 or might even be the same and not produce a level handle bar, depending of the preferences of the manufacturer and manufacturing costs. In one embodiment, the IIM 302 may include a base for attachment to an axle 301 (and as such may be provided separately from the stroller or as an upgrade or accessory), while in another embodiment, the IIM 302 may be built onto the axle 301 as shown. Accordingly, in some embodiments, the channel may be embedded in or formed from the axle, while in other embodiments the channel may be on a separate device and connected to the axle. In still other embodiments, a portion of an axle of each stroller may have a partial channel or non-circular portion (such as a D-shaped profile in corresponding sections of each axle) such that the two axles may mate together. Such embodiments may further incorporate a latch, clamp, lock, or other fastener to secure the axles together to join the strollers in a side-by-side configuration. In still other embodiments, the axles may have no channel or similar nesting means, but may still incorporate a latch or locking mechanism. In some such embodiments, the handles of each stroller may not be flush when in a side-by-side configuration, as one stroller may be in front of the other. To address this, in some embodiments, the strollers may have adjustable length handles or arms leading to handles, rotatable handles, or adjustable angles on the axle to allow the handles to be repositioned via tilting of the frame. In still other embodiments, a portion of each axle may have an anterior or posterior displacement relative to the other axle. For example, in one such embodiment, a “left” stroller may have a rear axle with a right side portion rotated at a first angle to the rear, and a “right” stroller may have a rear axle with a left side portion rotated at a first angle to the front, such that when joined, the two axle portions do not interfere. Other angles or anteroposterior displacements are possible. For example, a first stroller may have a rear axle that extends only laterally, while a second stroller may have a rear axle that has a portion that extends to the rear such that it will not intersect the axle of the first stroller when placed side-by-side. Accordingly, the strollers need not be identical or symmetrical, although in many embodiments they may be identical to reduce manufacturing costs and provide flexibility for the user.

The connection joint 302, where the two axles meet and attach may include a latch and release mechanism to facilitate the coupling and decoupling of the strollers. This attachment/detachment mechanism can take a variety of forms. For example, in many embodiments, the channel may include one or more pins (as shown), ridges or other features 303 for providing a secure connection to corresponding holes, channels, or negative features 304 in a corresponding portion of an axle 301 of a second stroller. The coupling stroller may include female spring-loaded latches 304 in some embodiments, that may snap in place as the two strollers are pushed to couple. The release mechanism can take a variety of forms corresponding to the respective attachment mechanism employed. For example and not limited to the case of the attachment mechanism depicted in FIG. 3, a lever, release button, or clamp on the coupling stroller that contains the female sockets will release the latches to decouple. Additional reinforcement mechanisms or alternative attachment mechanisms might be used as well to reinforce IIM's joint 403. For example a clamp (spring-loaded or manually-opened-and-closed) can be used to reinforce or connect the attachment point. Joint 403, where the two axles connect, might also be reinforced or held in place by a rotating lever (not shown) that would rotate open from the axle of one of the strollers and attach to the axle of the second stroller. Additional attachment/detachment mechanisms might be used at other locations of the stroller. For example a locking or latching mechanism might be incorporated to attach the handles of the two strollers to each other.

As illustrated in FIG. 5, in many embodiments, the front of the strollers can also be latched or attached together at the point where they meet. Left side of the right stroller 501 will meet the right side of the left stroller 502 and attach through latching mechanism 503 at the connection point. A variety of attachment/detachment mechanisms may be used to facilitate the coupling of the front of the two strollers, side by side, where the two frames meet. For example the frame of one of the strollers may include male spring loaded latches that would couple into corresponding female sockets on the coupling stroller and a release button or lever near the handles (illustrated with lever 102 in FIG. 1), or at other locations of the structure such as the front, could de-press the latches for decoupling. Alternatively or additionally, for example, a set of strong magnets 504 may be used to align and attach the frames in the front. In other embodiments, a manually-opened-and-closed clip or connector might connect the front of the two frames to each other where they meet. The front frames of the two strollers can be made to meet and attach to each other on the sides (as shown in FIG. 5) or alternatively they might be designed to overlap. In the overlapping configuration, the front frames may meet and attach in a way that one goes on top of its counterpart. For example, a male latching mechanism of a first stroller may be placed on a lower part of a frame of the first stroller and a female portion of the mechanism may be placed on a corresponding part of a frame of a second stroller. The overlap configuration might be adopted to save even more space in connecting the two strollers and make the total width of the double configuration even less.

In many embodiments, the double stroller may have a total width of 40″, 30″ or even less, allowing entry through narrow doorways. Additionally, given the ease of attachment and detachment process, the stroller may easily be detached and re-attached on-the-go for passing through smaller doors and openings.

FIGS. 6A-6B illustrates a further embodiment that could be used to save even more space when the two strollers are coupled. In this embodiment, the seat 604, 605 of each stroller is slidingly attached to a small railing 601, such that the seat may slide laterally outwards to the side as the two strollers are coupled. The railing may be spring loaded in some embodiments for added convenience where each stroller's seat will be positioned centrally relative to its own two back wheels 602 and 603 when the spring is in normal (i.e. non-compressed or non-stretched) position, or the railing may incorporate a latch to prevent lateral motion. As the two strollers are coupled to each other the seats 604 and 605 may slide outwards to the sides: for example, as shown in FIG. 6B, the seat of the left stroller 604 may slide to the left and the seat of the right stroller 605 may slide to the right. This will allow for the back wheels and axles 606 to overlap even more and cause the double configuration to be even less wide than in the implementation of FIG. 1. As the two strollers detach, the seats may slide back to the center of their frame and back-wheel span. Accordingly, when each stroller is used in its single configuration, the seats 604, 605 are in the middle of the back-wheel span 602, 603 of the corresponding stroller to ensure stability. When the stroller is in double configuration, the seats slide to the sides as the center of mass of the coupled configuration may be between each seat 604, 605, allowing each seats to extend all the way to the end of the wheel-span.

It should be clear that the description of the embodiments and figures mentioned in this application servers only for a better understanding of the invention without limiting its scope.

It should also be clear that a person skilled in the art, after reading the present specifications could make adjustments or amendments to the attached figures and abovementioned embodiments that would still be covered by the present invention.

I claim:

1. A detachable stroller for a side-by-side double stroller configuration, comprising:
a frame providing support for a seat for a child or infant;
at least one front axle attached to the frame, the at least one front axle attached to a corresponding at least one wheel; and
at least one back axle attached to the frame comprising:
a first portion of the back axle at a first angle to the ground, attached to the frame and attached to a second at least one wheel, comprising a channel of a first width across the first portion of the back axle at a second, different angle, and
a second portion of the back axle of the first width at the second angle, attached to the frame and attached to a third at least one wheel.

2. The detachable stroller of claim 1, wherein the channel further comprises at least one pin or ridge, and wherein the second portion of the back axle further comprises a corresponding at least one hole or channel.

3. The detachable stroller of claim 1, wherein the back axle further comprises a latch or clamp to secure the first portion of the back axle of the detachable stroller to a corresponding second portion of a back axle of a second detachable stroller.

4. The detachable stroller of claim 1, wherein the back axle further comprises a spring and pin attached to the spring to secure the first portion of the back axle of the detachable stroller to a corresponding second portion of a back axle of a second detachable stroller, and further comprising a release button to release the pin.

5. The detachable stroller of claim 1, further comprising a latch attached to the frame for connection to a corresponding portion of a frame of a second detachable stroller.

6. The detachable stroller of claim 1, wherein the back axle further comprises a third portion attached between the first portion and second portion, attached to the frame, said third portion having a height above ground of greater than a diameter of the second and third at least one wheels.

7. The detachable stroller of claim 1, wherein the frame further comprises a rail slidingly attached to the seat to allow the seat to move laterally between the center of the frame and a second predetermined position.

8. The detachable stroller of claim 7, further comprising a latch to prevent lateral movement of the seat in a single stroller configuration.

9. An interlacing mechanism for a double stroller, comprising:
a base for attachment to a first portion of a rear axle of a first stroller, the first portion at a first angle to the ground;
a channel, attached to the base, for attachment to a second portion of a rear axle of a second stroller, the second portion at a second, different angle, the channel at the second angle and having a width of at least a width of second portion of the rear axle of the second stroller;
wherein the first portion of the rear axle of the first stroller and the second portion of the rear axle of the second stroller interlace when connected to the interlacing mechanism.

10. The interlacing mechanism of claim 9, further comprising at least one pin or ridge attached to the channel for protruding into a corresponding at least one pin or channel of the second portion of the rear axle of the second stroller.

11. The interlacing mechanism of claim 9, further comprising a clamp attached to the base for attachment to the first portion of the rear axle of the first stroller.

12. The interlacing mechanism of claim 9, further comprising a clamp attached to the channel for attachment to the second portion of the rear axle of the second stroller.

13. The interlacing mechanism of claim 9, further comprising a latch attached to the channel for attachment to the second portion of the rear axle of the second stroller.

14. The interlacing mechanism of claim 9, further comprising a pin attached to a spring attached to the channel for attachment to the second portion of the rear axle of the second stroller, and further comprising a release button attached to the spring.

15. A detachable double stroller with an interlacing mechanism, comprising:
a first stroller comprising:
a first frame providing support for a seat for a first child or infant,
a first at least one front axle attached to the frame, the at least one front axle attached to a corresponding first at least one wheel, and
a first at least one back axle attached to the frame comprising a first portion of the back axle at a first angle to the ground, attached to the first frame and attached to a third at least one wheel, comprising a channel of a first width across the first portion of the back axle at a second, different angle; and
a second stroller comprising:
a second frame providing support for a seat for a second child or infant,
a second at least one front axle attached to the frame, the at least one front axle attached to a corresponding fourth at least one wheel, and
a second at least one back axle attached to the frame comprising a second portion of the back axle of the first width at the second angle, attached to the second frame and attached to a fifth at least one wheel; and
wherein the first stroller and second stroller are coupled with the second portion of the back axle of the second stroller detachably fastened in the channel of the first portion of the back axle of the first stroller.

16. The detachable double stroller of claim 15, wherein, when the first stroller and second stroller are coupled, the third at least one wheel attached to the first portion of the back axle of the first stroller is beneath the second frame of the second stroller, and the fifth at least one wheel attached to the second portion of the back axle of the second stroller is beneath the first frame of the first stroller.

17. The detachable double stroller of claim 15, wherein the first portion of the back axle of the first stroller further comprises at least one pin or ridge attached to the channel; and wherein the second portion of the back axle of the second stroller further comprises a corresponding at least one pin or channel.

18. The detachable double stroller of claim 15, wherein the first portion of the back axle of the first stroller or the second portion of the back axle of the second stroller further comprises a latch for securing the first portion and second portion together in a coupled configuration.

19. The detachable double stroller of claim 15, wherein, when the first stroller and second stroller are coupled, the total width of the double stroller is between 24 and 40 inches.

20. The detachable double stroller of claim 15, wherein the first frame of the first stroller further comprises a first rail slidingly attached to the first seat to allow the first seat to move laterally between the center of the first frame and a second predetermined position; and wherein the second frame of the second stroller further comprises a second rail slidingly attached to the second seat to allow the second seat to move laterally between the center of the second frame and a third predetermined position, the third predetermined position in an opposite direction from the second predetermined position.
